(19) United States
(12) Patent Application Publication
(10) Pub. No.: US 2009/0134644 A1
(43) Pub. Date: May 28, 2009

(54) APPARATUS FOR COLLECTING ANIMAL WASTE

(76) Inventor: Jerry C. Roberts, Oklahoma City, OK (US)

Correspondence Address: DUNLAP CODDING, P.C., PO BOX 16370, OKLAHOMA CITY, OK, 73113, US

(21) Appl. No.: 12/324,158

(22) Filed: Nov. 26, 2008

Related U.S. Application Data
(60) Provisional application No. 60/990,832, filed on Nov. 28, 2007.

(51) Int. Cl. A01K 29/00

(52) U.S. Cl. 294/1.4

(57) ABSTRACT

The present invention contemplates an apparatus for collecting animal waste. In one embodiment, the apparatus includes an elongated member having a first end and a second end. The apparatus further includes a tubular head that is operatively associated to one end of the elongated member, the tubular head having a leading end and an opposed trailing end and defining a bore extending between the leading end and the opposed trailing end of the tubular head. The apparatus also includes a bag positioned within the bore and selectively connected to the leading end of the tubular head and extending through the bore and the trailing end of the tubular head to define a receptacle for collecting litter, in particular, animal waste.

### CROSS-REFERENCE TO RELATED APPLICATIONS

This application claims priority to U.S. Provisional Application No. 60/990,832, filed on Nov. 28, 2007, which is hereby incorporated herein by reference in its entirety.

### BACKGROUND OF THE INVENTION

1. Field of the Invention

This invention relates generally to an apparatus for collecting and disposing of litter, and more specifically, but not by way of limitation, to an improved apparatus for collecting and disposing of litter in the form of animal waste.

2. Brief Description of Related Art

Millions of people in the United States and abroad have pets, such as dogs, that frequently drop excrement on lawns, sidewalks, in the home, and various other environments occupied and traversed by these animals. Consequently, there is a need for a device to aid the pet owner in quickly and sanitarily collecting and disposing of their pet's waste. The present invention is directed to address this need.

### BRIEF DESCRIPTION OF THE DRAWINGS

FIG. 1 is a perspective view of one embodiment of an apparatus for collecting animal waste constructed in accordance with the present invention.

FIG. 2 is a fragmental, sectional view of the apparatus for collecting animal waste.

FIGS. 3a-3d depict alternative embodiments of the apparatus for collecting animal waste.

### DETAILED DESCRIPTION OF EXEMPLARY EMBODIMENTS

Presently preferred embodiments of the invention are shown in the above-identified figures and described in detail below. In describing the preferred embodiments, like or identical reference numerals are used to identify common or similar elements. The figures are not necessarily to scale and certain features in certain views of the figures may be shown exaggerated in scale or in schematic in the interest of clarity and conciseness.

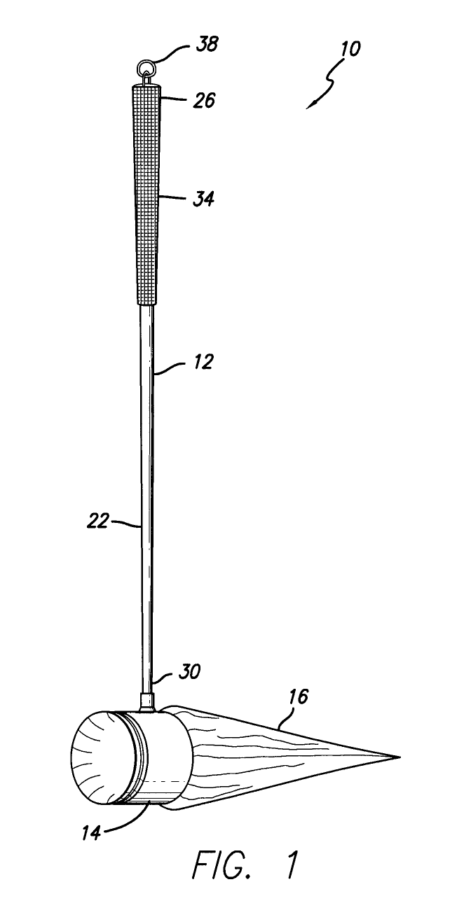

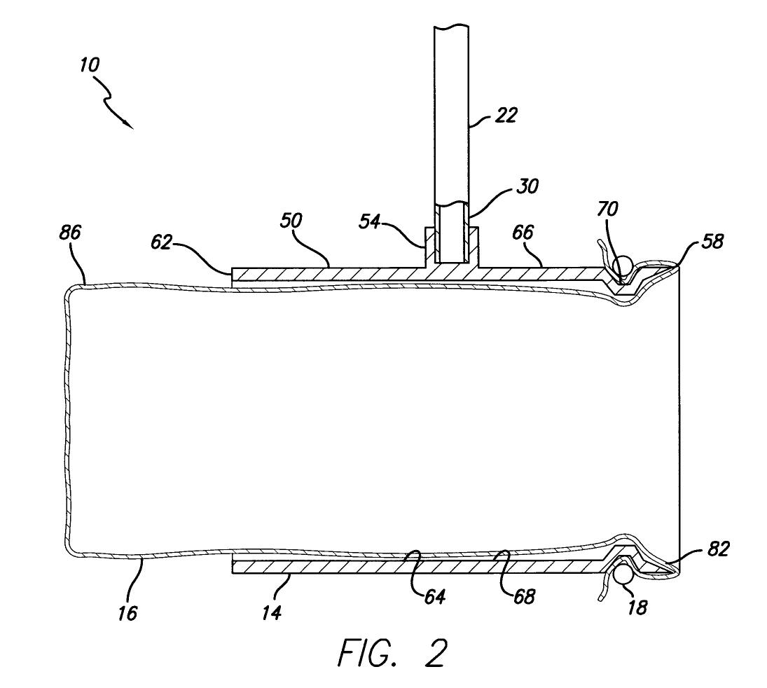

Referring now to the drawings, and in particular to FIG. 1, shown therein and designated by reference numeral 10 is an apparatus for collecting animal waste constructed in accordance with the present invention. In general, the apparatus 10 includes a handle 12, a tubular head 14 connected to one end of the handle 12, a bag 16 disposed through and detachably connected to the tubular head 14, and a retaining member 18 (shown in FIG. 2) for selectively securing the bag 16 to the tubular head 14.

The handle 12 includes an elongated member 22 having a first end 26 and a second end 30. The elongated member 22 may be constructed of various rigid and elastic materials, for example, and not by way of limitation, metal, wood, composite material, plastic, and rubber. The elongated member 22 may also be straight, curved, or telescopic in configuration, and constructed of various lengths. Preferably, the handle 12 has a grip 34 disposed on the first end 26 of the elongated member 22. The grip 34 can be constructed of any material suitable for gripping the apparatus 10, including, but not limited to, rubber, plastic, or composite material.

The first end 26 of the elongated member 22 may be constructed to receive a hanging member 38 to facilitate storage of the apparatus 10 when the device is not in use. The hanging member 38 can be any suitable structure or construction capable of interacting with a hanging structure, such as, but not limited to, a hook, nail, or peg. The hanging member 38 can be constructed of various rigid and elastic materials, including, but not by way of limitation, metal, rubber, plastic, or composite material. The hanging member 38 and the elongated member 22 may also be unitary in structure.

The second end 30 of the elongated member 22 is constructed to be connected to the tubular head 14. In one embodiment, the second end 30 of the elongated member 22 is shaped to be slidably received in a portion of the tubular head 14. In another embodiment, the second end 30 of the elongated member 22 may be threaded so that it may be threadably connected to the tubular head 14. The elongated member 22 and the tubular head 14 may also be unitary in structure.

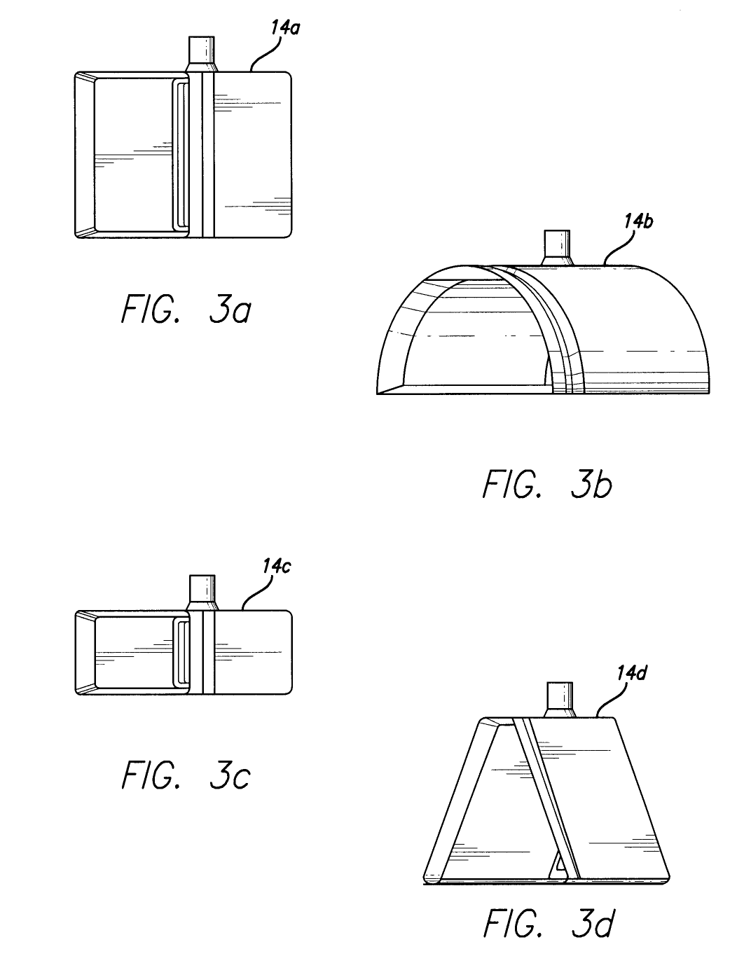

Referring now to FIG.2, the apparatus 10, and more specifically, the tubular head 14, is shown in more detail. In general, the tubular head 14 is provided with a tubular body 50 and a connection portion 54. The tubular head 14 can be constructed of various rigid and elastic materials, including, but not by way of limitation, metal, rubber, plastic, or composite material. The tubular head 14 can be a variety of geometric shapes, including, but not limited to, circular, semi-circular, square, rectangular, and triangularshapes (shown in FIGS. 3a-3d).

The tubular body 50 of the tubular head 14 has a leading end 58, a trailing end 62, and a bore 64 extending from the leading end 58 to the trailing end 62. The bore 64 is identical in shape to a cross-sectional piece of the tubular body 50, which can be a number of geometrical shapes, for example, but not by way of limitation, circular, semi-circular, square, rectangular, or triangular. The leading end 58 of the tubular body 50 defines a lead edge which is preferably tapered to facilitate the sanitary and efficient collection of animal waste from a surface.

The tubular body 50 is further characterized as having an exterior surface 66 and an interior surface 68. Moreover, the tubular body 50 is provided with an annular bag-receiving groove 70 on the exterior surface 66 of the tubular body 50, preferably near the leading end 58 of the tubular body 50. Alternatively, the groove 70 can be located along any portion of the exterior surface 66 of the tubular body 50 forward of the connection portion 54. Additionally, the groove 70 may extend about only a portion of the exterior surface 66 of the tubular body 50. While it is preferable for the groove 70 to be located on the exterior surface 66 of the tubular body 50, it should be understood that the groove 70 can be shaped in any structural configuration and be located on any portion of the tubular body 50 to facilitate the securing of the bag 16 in a manner to be described below.

The connection portion 54 of the tubular head 14 connects the tubular head 14 to the second end 30 of the elongated member 22 of the handle 12. The connection portion 54 may be constructed as a separate piece from the tubular head 14, and can be constructed from various materials, including, but not limited to, metal, plastic, wood, or composite material. Alternatively, the connection portion 54 and tubular body 50 may be unitary in structure. Preferably, the connection portion 54 defines a recess capable of slidably receiving the second end 30 (shown in FIG. 2) of the elongated member 22. It will be appreciated that the handle 12 may be secured to the connection portion 54 with any suitable adhesive or cohesive. In another embodiment, the connection portion 54 of the tubular head 14 may be threaded to threadably connect the connection portion 54 to the second end 30 of the elongated member 22.

The bag 16 of the apparatus 10 forms a disposable receptacle for the collection of animal waste. The bag 16 may be constructed from various materials, including, but not limited to, paper or plastic. In general, the bag 16 has an open end 82 and a closed end 86. The open end 82 of the bag 16 is secured to the leading end 58 of the tubular body 50 by positioning the open end 82 of the bag 16 over the groove 70 and securing the bag 16 in the groove 70 with the retaining member 18. The retaining member 18 can be a number of securing materials, including, but not limited to, an elastic cord, a rubber-band, or a spring. The retaining member 18 may be internal to the bag 16, located, for example, within the open end 82 of the bag 16. Alternatively, the retaining member 18 may be a separate piece of securing material capable of securing the bag 16 to the tubular head 14.

Once secured to the groove 70, the bag 16 covers the lip of the leading end 58 of the tubular head 14 and the interior surface 68 of the tubular body 50 as it extends through the bore 64. This configuration can be accomplished in a number of ways. In one embodiment, the bag 16 is secured in the groove 70 by the retaining member 18 and pushed through the leading end 58 of the tubular body 50 and disposed through the bore 64 to form a receptacle for collecting animal waste. Alternatively, the bag may be pushed through the trailing end 62 of the tubular body 50 and disposed through the bore 64 and then secured in the groove 70 with the retaining member 18. While it is preferable for the bag 16 to be secured in the groove 70 with the retaining member 18, it should be understood that the bag 16 can be secured to any portion of the tubular head 14 to form a receptacle to collect animal waste. By placing the bag 16 over the lip of the leading end 58 and interior surface 68 of the tubular body 50 and through the bore 68, the apparatus 10 offers the advantage of sanitarily collecting animal waste by preventing the waste from contacting any portion of the apparatus 10.

The apparatus 10 allows a user to sanitarily and efficiently collect animal waste. The animal waste-collecting function is preferably accomplished in the following manner; however, it should be understood that the animal waste-collecting function of the apparatus 10 is not limited to the following example. First, the user secures the open end 82 of the bag 16 to the groove 70 on the tubular body 50 with the retaining member 18. Once the bag 16 is secured, the user disposes the bag 16 through the bore 64 and over the lip of the leading end 58 of the tubular body 50. Next, the user, while holding the grip 34 on the handle 12 of the apparatus 10, utilizes a scooping, swing-like motion so as to dispose the animal waste in the bag 16.

After the animal waste is contained within the bag 16, the user can sanitarily detach the bag 16 from the groove 70 on the tubular body 50 by gripping the closed end 86 of the bag 16 and pulling the bag 16. This pulling action allows the bag 16 to be pulled through the bore 64 and the trailing end 62 of the tubular body 50, preventing the animal waste from coming into contact with either the apparatus 10 or the user. Once the bag 16 containing animal waste is detached from the apparatus 10, the user can dispose of the bag 16 in an appropriate trash-collecting receptacle.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed.

What is claimed is:

1. An apparatus, comprising:
an elongated member having a first end and a second end;
a tubular head connected to one end of the elongated member, the tubular head having a leading end and an opposed trailing end and defining a bore extending from the leading end to the opposed trailing end of the tubular head; and
a bag having an open end and a closed end, the bag extending through at least a portion of the bore with the open end of the bag secured about the leading end of the tubular head to define a receptacle.

2. The apparatus of claim 1, wherein the leading end is tapered.

3. The apparatus of claim 1, wherein the closed end of the bag extends beyond the trailing end of the tubular head.

4. The apparatus of claim 3, wherein the open end of the bag has a retaining member for securing the bag to the tubular head.

5. The apparatus of claim 1, further comprising a retaining member positioned about the open end of the bag to detachably secure the open end of the bag to the tubular head.

6. The apparatus of claim 5, wherein the leading end of the tubular head includes a peripheral groove for receiving the open end of the bag and the retaining member so as to facilitate the selective securing of the open end of the bag to the leading end of the tubular head.

7. A method for collecting animal waste, comprising:
securing an open end of a bag to a leading end of a tubular head, the tubular head defining a bore extending from the leading end to a trailing end;
disposing the bag through the bore such that the bag extends through at least a portion of the bore of the tubular head and the open end of the bag covers the leading end of the tubular head; and
moving the tubular head over the animal waste so as to cause the animal waste to pass into the bag via the open end without directly contacting the tubular head.

8. The method of claim 7, further comprising the step of disposing of the animal waste by detaching the bag from the leading end of the tubular head and pulling the bag through the bore such that the animal waste is prevented from contacting a user or the tubular head.
